(19) United States
(12) Patent Application Publication
(10) Pub. No.: US 2006/0201215 A1
(43) Pub. Date: Sep. 14, 2006

(54) Lock cylinder with key

(76) Inventor: Dejan Wolf, Brezovica (SI)

Correspondence Address: JACOBSON HOLMAN PLLC, 400 SEVENTH STREET N.W., SUITE 600, WASHINGTON, DC, 20004, US

(21) Appl. No.: 10/544,629

(22) PCT Filed: Feb. 10, 2004
(86) PCT No.: PCT/SI04/00007

§ 371 Date: Mar. 3, 2006

(30) Foreign Application Priority Data
Feb. 10, 2003 (SI) 2003-00035
Feb. 9, 2004 (SI) 2004-00044

(51) Int. Cl. E05B 17/18

(52) U.S. Cl. 70/423; 70/455

(57) ABSTRACT

A lock cylinder placed in an optional lock (A) positioned on an optional door (B) and consisting of a housing (1), preferably having standard external dimensions, shape and type, of an optional plug (2) with a cam (18) that act on the mechanism of the lock (A), of a knob (5) for manual unlocking and locking of the lock (A) from the side of the room locked by the lock (A) is positioned on the front side of the insert on that side of the door (B), from which a room to be locked is entered, whereas the cylinder is provided with a protecting element, preferably in the form of a protecting cover (13) allowing authorized access to the slot in the pin (2) for a key, whereby said protecting element is entirely fit in the seat (40) arranged in a security escutcheon (39) positioned on the door (B).

### SUBJECT OF INVENTION

The subject of the invention is a lock cylinder with a key, whereas the cylinder is designed in a way to be resistant to drilling or breaking and prevents the key slot in the cylinder from being stuffed, and a belonging key specially designed to allow removal of a security cover when the latter is pressed down.

The invention belongs to class E05B 17/14 of the international patent classification.

### TECHNICAL PROBLEM

A technical problem solved by the invention is how to conceive a lock cylinder with a key available in the form of all standard variants with respect to their form, build-in dimensions, selection of material of individual parts as well as construction of pins e.g. single, composed, modular and the like, whereas the cylinder will be resistant to drilling or breaking and will prevent the key slot from being stuffed; handling the lock cylinder for locking and unlocking and also for additional protection against drilling and breaking will be user friendly and will meet high security standards.

### PRIOR ART

Known cylinders have various construction solutions intended to prevent unauthorized unlocking or moving a pin. There are cylinders with cylinder pins guided in a groove and retained with springs. A specially designed key lifts these cylinder pins in different ways thus allowing a keyhole plug to move.

Security cylinders of this type are usually equipped with an owner card and undergo controlled distribution of keys, available only from authorized producers. Such cylinders provide protection against simple key falsifications, yet do not provide sufficient protection against drilling or any other physical removal of the cylinder.

There is a multitude of solutions which prevent access to the cylinder, which do, however, not satisfactorily solve the set technical problem.

There is a solution described in the EP patent No. 0 367 000, according to which a certain protecting device—security cover is used, said cover also covering the access to the cylinder. In order to remove this cover a special device should be used to set pins to a defined combination thus disabling removal. The solution is complicated to be produced due to a large number of precisely manufactured elements, it is moreover also inappropriate for use, because a special device is needed for opening apart from a key. Furthermore, this solution does not offer satisfactory security against drilling.

There is also a solution described in the patent specification DE 199 38 268, whereas the displacement of a security cover from the external side via the gap of a cylinder is implemented by means of an electromagnetic sealing device, triggered via a radio transmitter. The solution is applicable only in conjunction with the entire door handle and a specially adapted security cover and cannot be universaly applicable.

Apart from the mentioned embodiments there are also solutions like for instance described in patent documents U.S. Pat. No. 6,397,647 and EP 0 845 565, which do not offer satisfactory antitheft protection and only allow the protection of the slot against being filled or getting filthy.

### SOLUTION TO THE TECHNICAL PROBLEM

A cylinder with a security cover and a belonging key according to the invention which successfully solves the set technical problem contains in the housing apart from a plug also an encoded signal receiver with control electronics, whereas under the plug there is a bushing with a spring and above the bushing there is a trap with a coil and a movable locking pin and on the internal side of the security cover there is a guide at one end, represented by an axle with a drilled hole and a groove and a pin at the other end.

In order to adapt the security cylinder of the invention to various thicknesses of a door, said cylinder being of an optional structure and with the same standard lengths as optional known cylinders of this type, there is also a security escutcheon which will be available on the market in a variety of thicknesses in order for the selected length of the cylinder of the invention to match any thickness of a door within standard dimensions. This solution is important because a security cover of a cylinder covering the front panel of a cylinder of the invention and preventing drilling or filling of a keyhole is arranged in a way to precisely fit the adequate seat in the security escutcheon, which is additionally rendered by an adequate positioning element in the cover and on the front part of the cylinder, which prevents a security cover or a cylinder from being broken, there is namely no tool or device to achieve such a grip of the cover or cylinder to break it.

A further novelty of the cylinder of the invention lies in that it has a predetermined mode of inactivation of the security element: (1) via a coil and an anchor with a pin, whereas said coil loosens the anchor in the guide upon a remote command via an encoding signal transmitted by the user via a transmitter in the key, whereby a spring pushes said guide back from the front panel of the cylinder, when a user can twist it in a way to get a free access with a key to the slot for the key in the cylinder and also (2) via an electric motor, which on the basis of a command via a transmitter, positioned anywhere, and with which a user by using a special security encoded signal triggers the entire automatic procedure of shift of the security cover from the seat in the security escutcheon so that the cylinder is prepared for unlocking with a key and after the unlocking and/or locking also for automatic repositioning of the security cover into the seat in the security escutcheon thus protecting the cylinder against violent intervention.

There is also an open possibility of an additional arrangement of the cylinder for upgrade with various sensors in the cylinder itself or in its vicinity, said sensors detecting forces excerted on the door as a whole or only on the cylinder thus detecting violent intervention. The measured values in the sensors are processed in an adequate device, preferably a micro computer, which triggers adequate commands with respect to the type and size of values detected by sensors.

Such solution also offers various possibilities of power supply of all electric and electronic devices in the cylinder and its vicinity. A power source may thus be a battery, placed in the door handle on the interior side of the door or led via a line from a remote source. It is also foreseen to have a control over electric power supply and especially in the case of a battery also timely alarm or a warning of low energy. There is also a technical procedure when an authorized person is to intervene due to the loss of a key, change of a battery and other technical interventions in case of irregularities, which can emerge when using and abusing the lock cylinder of the invention.

Control of operation of the security cover from the outside when a lock is being unlocked and locked can also be implemented in an optional known way via radio signals, IR signals; it is also possible to use various identification cards with a magnetic or differently written code. A code may also be entered via a phone or a mobile phone, said code triggering the procedures of inactivation or activation of the security cover and thus also the operation of parallel security systems via sensors and the like.

The essence of the invention will now be described in more detail by way of an embodiment and with reference to the accompanying drawings in which:

FIG. 1 shows a schematic view of the first embodiment of a lock cylinder of the invention in partial cross-section and from a side;

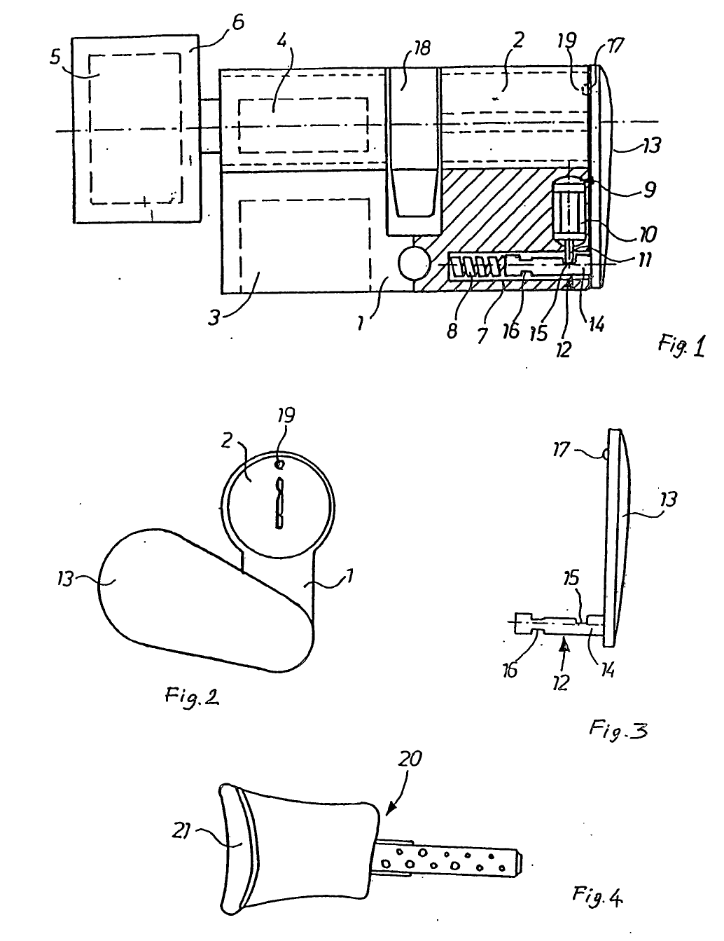

FIG. 2 shows a schematic view of the first embodiment of a lock cylinder of the invention in the front view from a side of locking and unlocking and with a partially twisted security cover;

FIG. 3 schematic view of the security cover from a side;

FIG. 4 schematic view of a key;

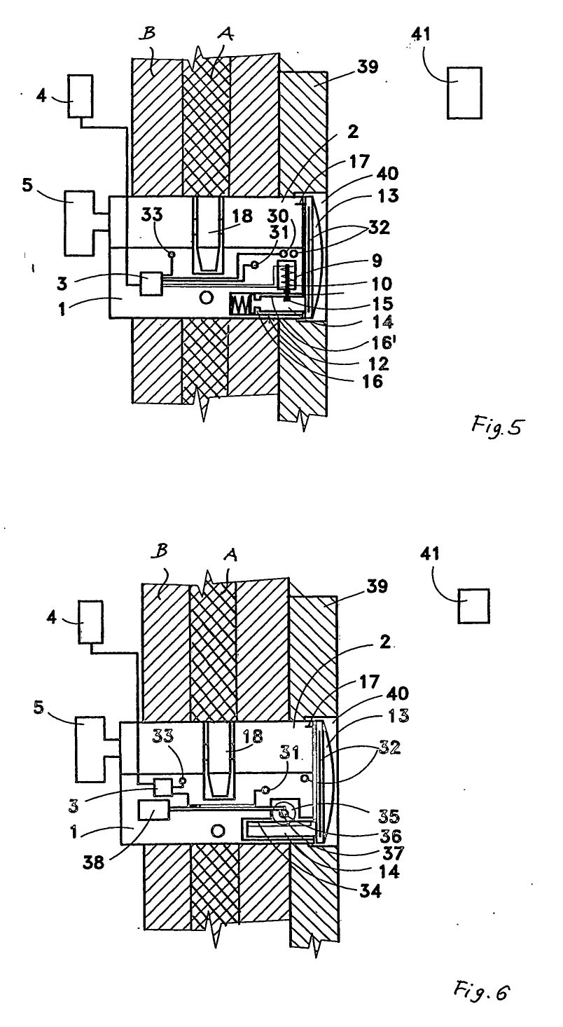

FIG. 5 longitudinal section of a lock cylinder according to the second embodiment of the invention and built into the door; and

FIG. 6 longitudinal section of a lock cylinder according to the third embodiment of the invention and built into the door.

FIG. 1 is a schematic view of the first embodiment of a lock cylinder of the invention in partial section. In a housing 1 there is a plug 2, a receiver 3 of an encoded signal with control electronics and a spare battery 4, whereas in a knob 5 there is a main battery 6. Under the plug 2 there is a bushing 7 with a spring 8. In the housing 1 there is a breech 9 represented by a coil 10 with a moving breeching pin 11. A security cover 13 on the front side of the lock cylinder of the invention has a guide 12 on the internal side at one end, said guide consisting of an axle 14 with a drilled hole 15 and a groove 16, and a pin 17 on the other.

The external dimensions and the shape of the housing 1 are the same as with a standard lock cylinder, so a replacement is possible without any additional intervention when placed in the existing locks A on a door B.

Apart from standard parts like the plug 2 of a cylinder and a cam 18 there are additional elements positioned in the housing 1, which allow triggering and fastening of a security cover 13. The security cover 13 is a constructional element made of materials resistant to drilling, its external surface is moreover slightly convex, which also renders drilling and/or breaking impossible; the internal surface of the security cover 13 fitting the external shape of the cylinder is plane.

The security cover 13 has a guide 12 on the bottom side, said gide being represented by an axle 14 with a drilled hole 15 and a groove 16. On the upper part of the axle 14 between the drilled hole 15 and the groove 16 is somewhat chamfered, which is evident from FIGS. 1 and 3, otherwise it is adjusted to the bushing 7 lying under the plug 2 of the cylinder. In the bushing 7 there is a spring 8.

Above the bushing 7 in the housing 1 there is a breech 9, which upon activation of a coil 10 triggers a breaching pin 11 made of a ferrite steel material by pushing the pin into the drilled hole 15 of the axle 14. The security cover 13 must therefore be pushed against the front side of the plug 2 of the cylinder and turned in a way that the pin 17 lies in the groove 19 arranged in the plug 2 of the cylinder. Thus the security cover 13 is positioned and covers the entire front side of the cylinder of the invention and renders it impossible to access the slot either by key or for unauthorized interventions.

The security cover 13 is inactivated by taking out the breeching pin 11 from the drilled hole 15 on the axle 14. With the breeching pin 11 taken out, immediate activation of the coil 10 is enabled by the security cover 13 which starts moving from the front side of the plug 2 of the cylinder due to the operation of the spring 8 on the axle 14. The breeching pin 11 moves along the cut upper part of the axle 14 until fitting the groove 16. Thus the security cover 13 cannot fall out, it can though be turned around the axle 14 and allow access to the opening for the key on the front side of the plug 2 of the cylinder.

The security cover 13 is simply positioned by being turned manually into upright position and by being pushed against the front side of the plug 2 of the cylinder. The breeching pin 11 again falls into the drilled hole 15 on the axle 14 and the pin 17 fits into the groove 19 on the front side of the plug 2 of the cylinder.

The coil 10 can be activated and inactivated by means of the receiver 3 of an encoded signal charged with the battery 6 in the knob 5 or in case of power failure with a spare battery 4. The receiver 3 is activated by means of a transmitter which can be integrated in a key.

A constituent part of the invention is also a specially designed key 20, which—when the security cover 13 is pushed—excerts mechanical force to push the spring 8 and positions the security cover 13. A lug 21 of the key 20 imitates a part of the external surface of the security cover 13. Such lug 21 of the key 20 can be used upon simultaneously activating the transmitter and pushing the front part of the security cover 13 to simply remove the security cover.

The cylinder with a security cover and the belonging key of the invention has its own power supply with electricity (main battery 6 and spare battery 4), there is also an option of external power supply (e.g. battery in the key and transfer of electricity via contacts in the security cover 13).

The structure and implementation of the subject of the invention moreover allow an option of independent communication of the cylinder of the invention with an information centre in case of violent opening (drilling, breaking . . . ), which can be implemented by sending a SMS message.

A lock cylinder of the second embodiment is an upgrade of the first embodiment of the invention having sensors for detection of unauthorized use of a lock A and/or door B in the cylinder, a sensor 30 in the vicinity of the coil 10 detecting the removal of the breeching pin 11 from the hole 15. This sensor is preferably designed as an end switch. Only after an entry of the proper code into the receiver 3 its microprocessor allows the procedure for the moving of the security cover 13 and switch-on of the sensor 30. If the sensor 30 is turned on without a prior entry of the code into the receiver 3, it should be understood that an unauthorized intervention is in course and the microprocessor in the receiver 3 triggers the programmed security procedure, e.g. notifies the control centre, triggers the alarm etc.

Furthermore, in the housing 1 and/or anywhere on the door A there is at least one sensor 31 detecting vibrations in its vicinity. Detection threshold is set in a way that the sensor 31 allows the vibrations caused by normal use of the door or lock. When there are vibrations present at burglaries, the predetermined security procedure is carried out via the microprocessor in the receiver.

In order to extend the time of entering in case of burglary with cutting or grinding tools, there are inserts 32 in the security cover 13 and optionally also in the housing 1 in the vicinity of the cover 13, said inserts being in the shape of cylinder needles or balls of very hard materials. The inserts 32 are positioned in a way that a cutting or grinding tool first touches them before the stability of the cylinder loosens up to the point to lose its locking function.

If the cylinder of the invention is foreseen to be used in conditions where an authorized access into the insert or door is foreseen with means sensible among others to changed temperature, e.g. very increased or decreased temperature from room temperature, a temperature sensor 33 can be built in, the detected temperature of which is transmitted into the microprocessor in the receiver 3 to trigger predetermined security procedures.

In the second embodiment the transmitter acts on the receiver in the cylinder only to inactivate and activate the pin 11, so that the spring 8 removes the security cover 13 from the front panel of the cylinder, so that the user can turn it downwards thus having access to the slot in the keyhole, whereas the handling according to the third embodiment is more automated and will be described in the continuation. The cover 13 is foreseen to be placed in a security escutcheon in order to prevent any touching of the security cover 13 with means that could damage the cover thus achieving unauthorized access to the slot of the cylinder.

The novelty of the cylinder according to the third embodiment lies in that the axle 14 is provided with transversally runng teeth 34 with a toothed wheel 35, on an axle 36 of which running rectangularly and parallel to the axle 14 there is a worm 37 driven by an electric motor 38. The electric motor 38 is connected to power source which can be a battery positioned in the cylinder, preferably in the handle on the internal side of the door. The security cover 13 can be turned manually on the axle 14 in the remote position from the front panel of the cylinder in a known way. Thus a user can access the slot in the cylinder to unlock or lock the door.

All embodiments of the lock cylinder are intended to be positioned in the door A of an optional thickness. The cylinders are therefore of various lengths, preferably stagewise. On the part of the door with the security cover 13 there is preferably a security escutcheon 39 of an optional shape depending on the aesthetic view an individual cover should express. An essential characteristic of such escutcheon 39 is in that it has a seat 40 of the security cover 13. The seat 40 allows the security cover 13 to be entirely embedded in it when it leans against the front panel of the cylinder in order to prevent access to the slot for a key.

In order for the cylinder to be suitable for unlocking and locking it is activated via the described key, but can also be activated in various known ways via a transmitter 41 transmitting an encoded signal which triggers the procedure of activation or inactivation. The encoded signal can be sent from the transmitter 41 as radio waves or IR beams, whereas the transmitter 41 can be hidden in the key or a special unit. Moreover we can have a unit acting on the magnetic encription on a card, said card being positioned on an optional place, also hidden or in a different location from the keyhole. A stationary or mobile phone can also be used to send an encoded signal to the receiver 3 in the keyhole.

The security cover 13 can be optionally designed in the sense of industrial design, however, a fact should be considered that the shape should also prevent operation of an optional element, which could remove the security cover from the front panel of the cylinder.

It is understandable that a man skilled in the art can design other embodiments of the cylinder based on the above description or embodiments as well as products of the above description without circumventing the characteristics of the invention defined in the attached patent claims.

1 Lock cylinder placed in an optional lock (A) positioned on an optional door (B) and consisting of a housing (1), preferably having standard external dimensions, shape and type, of an optional plug (2) with a cam (18) that act on the mechanism of the lock (A), of a knob (5) for manual unlocking and locking of the lock (A) from the side of the room locked by the lock (A), characterized in that on the front side of the insert on that side of the door (B), from which a room is entered and is locked by the insert of the invention, is positioned a part of a protecting element, preferably in the form of a protecting cover (13) allowing authorized access to the slot in the pin (2) for a key, whereby said protecting element is entirely fit in the seat (40) when a lock is protected, said seat being arranged in the security escutcheon on the door (B).

2 Lock cylinder according to claim 1, characterized in that a protecting element consists of a security cover (13) embedded with its axle (14) in a bushing (7) arranged in a housing (1), whereby in the axle (14) there is a drilled hole (15) and a groove (16) and part of the coating of the axle (14) between the drilled hole (15) and the groove (16) is made by a chamfering (16′), whereas in the axial direction of the axle (14) acts a spring (8) and of a breech (9) consisting of a coil (10) with a pin (11) from a ferrite steel material, whereby the breech is positioned with respect to the axle (14) in a way that in the security mode of the protecting cover (13) the pin (11) lies in the drilled hole (15), whereas in the mode of the activated coil (10) the pin (11) lies outside the drilled hole (15), thus allowing the spring (8) to push the axle (14) and simultaneously the protecting cover (13) from the seat (40) in the escutcheon (39) in order for a user to be able to turn it, thus loosening access to the slot in the plug (2) with a key.

3 Lock cylinder according to claim 1, characterized in that a protecting element consists of a protecting cover (13) embedded with its axle (14) in a bushing (7) in a housing (1), whereas the axle (14) is provided with transversally running teeth (34) with a toothed wheel (35), on an axle (36) of which running rectangularly and parallel to the axle (14) there is a worm (37) driven by an electric motor (38) so that upon an adequate command of a user the protecting cover (13) is placed outside a seat (40) in an escutcheon (39) allowing the user to manually twist it thus loosening access to the slot in the plug with a key.

4 Lock cylinder according to claim 1, characterized in that in a plug (2) there is a sensor (30) in the vicinity of a coil (10) detecting any displacement of a pin (11) from a drilled hole (15) in a way that only after a previous entering of an adequate code into a receiver (3) its microprocessor allows a procedure for displacement of a security cover (13) upon the switch-on of the sensor (30), in the opposite case the foreseen security procedure is turned on, e.g. messaging to a supervisory system, triggering of an alarm etc.

5 Lock cylinder according to claim 1, characterized in that in a housing (1) and/or anywhere in a lock (A) or in a door (B) there is at least one sensor (31) detecting vibrations in its vicinity, whereby detection threshold is set in a way that the sensor (31) allows the vibrations caused by normal use of the door or lock, whereas upon vibrations present at burglaries, the predetermined security procedure is carried out via a microprocessor in a receiver (3).

6 Lock cylinder according to claim 5, characterized in that there are inserts (32) in a security cover (13) and optionally also in a housing (1) in the vicinity of the cover (13) preferably in the shape of cylinder needles or balls of materials resistant to cutting or grinding, preferably in a rotating way.

7 Lock cylinder according to claim 1, characterized in that an integration of a temperature sensor (33) is foreseen, the detected temperature of which is transmitted into the microprocessor in a receiver (3) to trigger predetermined security procedures.

8 Lock cylinder according to claim 1, characterized in that a security cover (13) is positioned in the mode of protection of a lock in a security escutcheon (39) in order to prevent any touching of the security cover (13) with means that could damage the cover thus achieving unauthorized access to the slot of the cylinder.

9 Lock cylinder according to claim 1, characterized in that a power source can be a battery positioned in the cylinder, preferably in the handle on the internal side of the door delimiting the room locked by the door, or an external source, positioned on the side of the door delimiting the room locked by the door.

10 Lock cylinder according to claim 1, characterized in that a security cover (13) can be turned manually on an axle (14) in the remote position from the front panel of the cylinder.

11 Lock cylinder according to claim 1, characterized in that a housing (1) of the security cylinder and an escutcheon (39) are dimensionally adapted to optional thicknesses of a door.

12 Lock cylinder according to claim 1, characterized in that activation and inactivation of operation of a cylinder is suitable for unlocking and locking is implemented in various known ways via a transmitter (41) transmitting an encoded signal which triggers the procedure of activation or inactivation, whereby the encoded signal can be sent from the transmitter (41) as radio waves or IR beams, whereas the transmitter (41) can be placed in a key or a special unit.

13 Lock cylinder according to claim 1, characterized in that for sending an encoded signal there is a unit acting on the magnetic encription on a card, said card being positioned on an optional place, also hidden or in a different location from the keyhole.

14 Lock cylinder according to claim 1, characterized in that for sending an encoded signal a stationary or mobile phone can be used to send an encoded signal to a receiver (3) in the keyhole.

15 Lock cylinder according to claim 1, characterized in that for sending an encoded signal a transmitter positioned in a key is used.

16 Lock cylinder according to claim 1, characterized in that a security cover (13) can have a pin (17) on the adjacent side of its plug (2), whereas the pin (17) can be positioned in an adequate groove (19) in the plug (2) or a housing (1).
